(19) United States
(12) Patent Application Publication
(10) Pub. No.: US 2008/0201373 A1
(43) Pub. Date: Aug. 21, 2008

(54) EVALUATOR CREDIBILITY BASED CONTENT CREDIBILITY EVALUATION APPARATUS AND METHOD THEREOF

(75) Inventors: Sang-Il AHN, Seoul (KR); Hyoung-Joo Kim, Seoul (KR)

Correspondence Address: NEAL, GERBER, & EISENBERG, SUITE 2200, 2 NORTH LASALLE STREET, CHICAGO, IL, 60602, US

(73) Assignee: REBI SEARCH CORPORATION, Seoul (KR)

(21) Appl. No.: 12/032,092

(22) Filed: Feb. 15, 2008

(30) Foreign Application Priority Data
Feb. 15, 2007 (KR) 10-2007-0016204

(51) Int. Cl. G06F 17/30

(52) U.S. Cl. 707/104.1; 707/E17.009

(57) ABSTRACT

An evaluator credibility based content credibility evaluation apparatus and method thereof are disclosed. A content credibility e valuation method that includes obtaining evaluation information of a content evaluator about content; obtaining credibility of the content evaluator from a user information database; and calculating content credibility based on the credibility of the content evaluator and the evaluation information, allows consideration of the content evaluator's credibility in content credibility evaluation and enhancement of online search engine performance.

### CROSS REFERENCE TO RELATED APPLICATION

This application claims the benefit of Korean Patent Application No. 10-2007-0016204 filed with the Korean Intellectual Property Office on Feb. 15, 2007, the disclosure of which is incorporated herein by reference in its entirety.

### BACKGROUND

1. Technical Field

The present invention relates to content credibility evaluation apparatus and method thereof and more particularly, to an apparatus for evaluating the content credibility based on the credibility of content evaluators and the method thereof.

2. Description of the Related Art

It is a valuable work to find credible contents from online. Contents consumers need to be provided with more valuable and credible contents. For this need, there have been some trials to evaluate the value or the credibility of contents. For example, the value of a particular content has been indirectly determined based on the number of contents that refer the content by hyperlink. But, since it is a mere indirect reflection of people's responses about the content, it is not adequate to deal with people's direct evaluation participation in a new web atmosphere.

### SUMMARY

An aspect of the invention is to provide content credibility evaluation method considering evaluator credibility. Also, an aspect of the invention is to provide content credibility evaluation apparatus considering evaluator credibility.

One aspect of the invention provides content credibility evaluation method that comprises obtaining evaluation information of content evaluator about content; obtaining credibility of the content evaluator from a user information database; and calculating content credibility based on the credibility of the content evaluator and the evaluation information.

The content credibility evaluation method may further comprise updating credibility of content poster of the content, based on the content credibility. The content credibility evaluation method may further comprise updating credibility of content evaluator based on the content credibility and the evaluation information.

The updating credibility of content poster and the updating credibility of content evaluator may be performed in case an evaluation ending time is reached. The updating credibility of content poster and the updating credibility of content evaluator may be performed in case the content credibility is statistically significant.

Another aspect of the invention provides content credibility evaluation apparatus that comprises content information obtaining part configured to obtain evaluation information of content evaluator about content, from a user terminal; a user information obtaining part configured to obtain credibility of the content evaluator from a user information database; and content credibility calculating part configured to calculate the content credibility based on the credibility of the content evaluator and the evaluation information.

The content credibility evaluation apparatus may further comprise a user credibility updating part configured to update credibility of the content evaluator and/or content poster of the content, based on the content credibility.

The content credibility evaluation apparatus may further comprise content evaluation ending condition determining part configured to determine whether evaluation ending time is reached. The content credibility evaluation apparatus may further comprise content credibility significance determining part configured to determine significance of the content credibility.

The content may be a general term that refers to digital information and subject matters which may be provided through wired/wireless network. The content may be news, people's opinions and blog postings. The content may be subject matters and questions of online survey. The content may be a UCC (user created content) and PCC (proteur created content) type.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 illustrates content credibility evaluation apparatus according to an embodiment of the invention.

FIG. 2 is a flow chart of content credibility evaluation method according to an embodiment of the invention.

FIGS. 3A to 3C illustrate scaling functions according to an embodiment of the invention.

FIGS. 4A to 4C illustrate calculation results according to an embodiment of the invention.

FIG. 5 is a distribution of the evaluation grade given by content evaluators according to an embodiment of the invention.

### DETAILED DESCRIPTION

Embodiments of the evaluator credibility based content credibility evaluation apparatus and method thereof according to certain aspects of the invention will be described below in more detail with reference to the accompanying drawings. In the description with reference to the accompanying drawings, those components are rendered the same reference number that are the same or are in correspondence regardless of the figure number, and redundant explanations are omitted. Also, the basic principles will first be described before discussing the preferred embodiments of the invention.

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

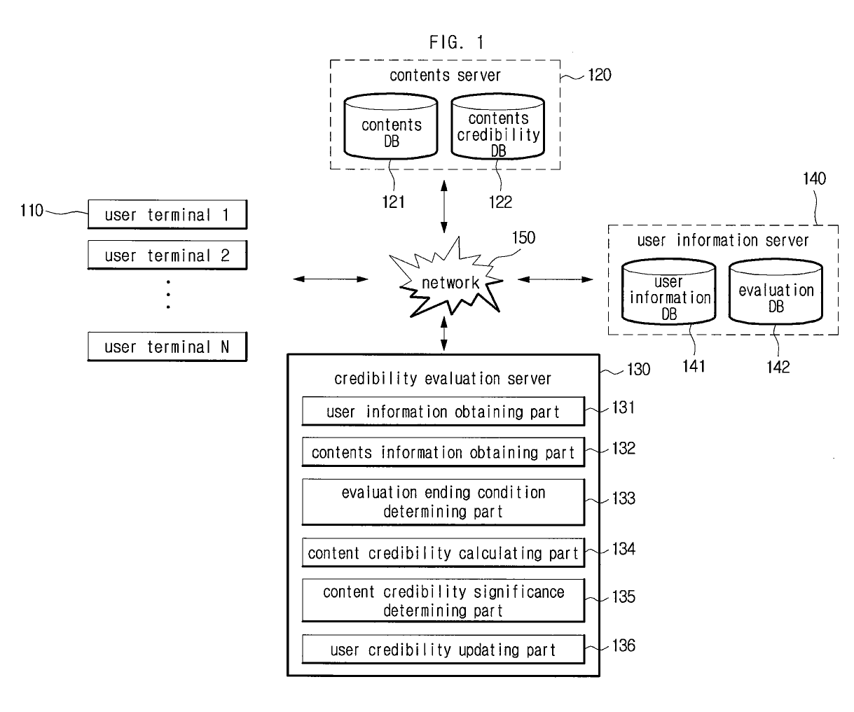

FIG. 1 illustrates content credibility evaluation apparatus according to an embodiment of the invention.

Referring to FIG. 1, the content credibility evaluation apparatus may include a user terminal 110, content server 120, a credibility evaluation server 130 and a user information server 140. Each terminal and servers may be connected by a network 150. The function of disclosed elements may be understood, referring other figures for embodiments of the invention.

It is obvious that the severs 120, 130, 140 may be merged to one server or more servers. But, hereinafter, the content server 120, the credibility evaluation server 130 and the user information server 140 may be described as independent servers for convenience.

The user terminal 110 may display content stored in the content server 120 by receiving through the network 150. In an embodiment of the invention, a user may input an evaluation grade including for or against opinions about content or selective opinions in online survey by an input unit of the user terminal 110.

An input method of an evaluation grade for content may be varied according to content evaluation types. For example, providing a ‘for and against’ opinion for content, marking (grading) for content and providing a selective opinion for an online survey may be requested as an evaluation grade.

A response of a user to these requests may be inputted to the user terminal 110, transmitted through the network 150, and stored in an evaluation information database 142. The user terminal 110 may be also used for inputting information for user identification. Any device that can display content and transmit evaluation information for the content through the network 150—for example, a PC (personal computer), a mobile phone and a PDA (personal digital assistant) etc.—may be utilized as the user terminal 110.

The content server 120 may include content database 121 and content credibility database 122. The content database 121 may store content and content information to be provided to a user. The content credibility database 122 may store content credibility transmitted from the credibility evaluation server 130.

The content server 120 may provide content to the user terminal 110 upon a request. The content server 120 may provide an input method for an evaluation grade with the content. A user can be a content evaluator by inputting an evaluation grade for the content. The content server 120 may send an evaluation grade given by the content evaluator to the user information server 140. The content server 120 may send content information to the credibility evaluation server 130, by a request of a content information obtaining part 132. Also, the content server 120 may provide a content credibility, calculated by the credibility evaluation server 130 and stored in the content credibility database 122, to a user.

The credibility evaluation server 130 may calculate a content credibility based on a credibility of the content evaluator and evaluation information. Also, credibility of a user who posted content (hereinafter ‘a content poster’) may be considered in the content credibility calculation.

Referring to FIG. 1, the credibility evaluation server 130 may include a user information obtaining part 131, a content information obtaining part 132, a content credibility calculating part 134 and a user credibility updating part 136. Also, the credibility evaluation server 130 may further include an evaluation ending condition determining part 133 and a content credibility significance determining part 135.

Content credibility may be understood as an indirect measure on a content evaluator approval to the opinion of a content poster in content, or an indirect measure for usefulness of content, not a direct measure for veracity of content itself. The content credibility may be a relative grade compared to a full mark for a mark giving type content evaluation. The content credibility may be a measure representing an approval rating for a for/against opinion type content evaluation. The content credibility may be a measure representing approval ratings of content evaluators for each selective response in online survey. Hereinafter, for convenience, a mark, a for/against opinion, a response of selective opinion etc. given by a content evaluator may be noted as ‘an evaluation grade’.

The user information obtaining part 131 may obtain user information from the user information database 141 and evaluation information of a content evaluator from the evaluation information database 142. The obtained user information and evaluation information may be transmitted to the content credibility calculating part 134 and be a basis for calculating a content credibility. The user information may be stored in the user information database 141.

The user information is information about a user (including content poster and content evaluator). The user information may include user identification information such as a user login ID, additional information about user profile, user credibility information and user credibility modification history information.

The evaluation information may be information about a response for the content inputted to the user terminal 110 by a user. The evaluation information may include identification information of the content, a mark for the content given by a content evaluator, a for/against opinion for the content, a selective opinion in an online survey and response time information. The evaluation information may be stored in the evaluation information database 142 of the user information server 140. The evaluation information may be stored for each user. A evaluation history information for a content evaluator may be stored in the evaluation information database 142. Meanwhile, the evaluation information may be stored in the content database 121 with user identification information.

The content information obtaining part 132 may obtain content information from the content database 121 of the content server 120. In an embodiment of the invention, the content information may include content identification information, a content evaluation ending condition and content evaluation type information. Also, the content identification information may include information about a theme (subject matters) of the content. The content evaluation ending condition may be transmitted to the evaluation ending condition determining part 133, and the content evaluation type information may be transmitted to the content credibility calculating part 134. The content evaluation type may include a mark giving, a for/against voting, a selective opinion giving.

The evaluation ending condition determining part 133 may determine whether an additional response (evaluation) by a user may be accepted or not. An evaluation ending condition obtained by the content information obtaining part 132 may be utilized. In an embodiment of the invention, the evaluation ending condition may be an evaluation ending time and/or a minimum required number of evaluators. Theses ending conditions may be set by a content poster. Also, satisfaction of the minimum number of evaluators to make the content credibility significant may be considered as a premise condition for evaluation ending.

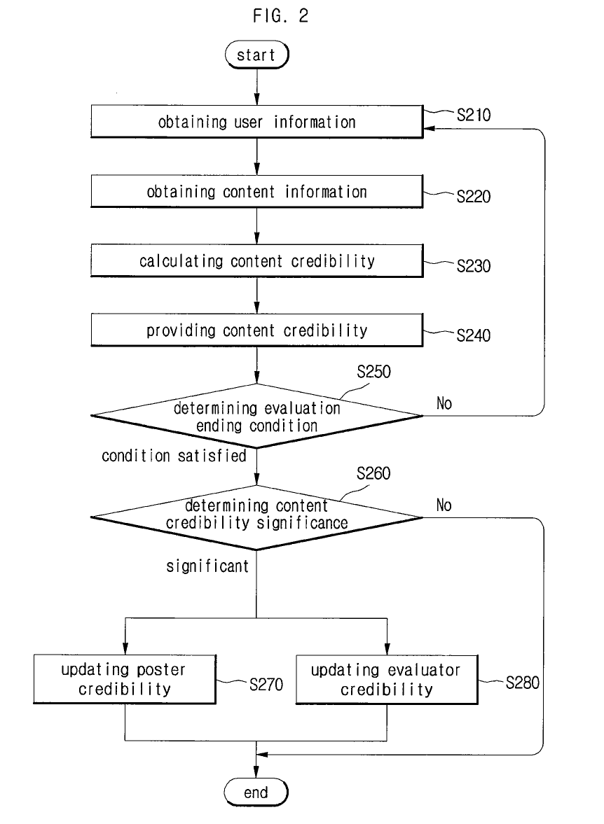

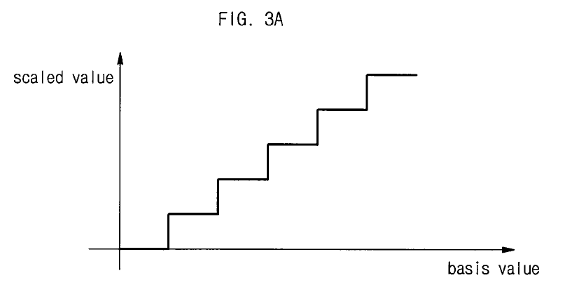

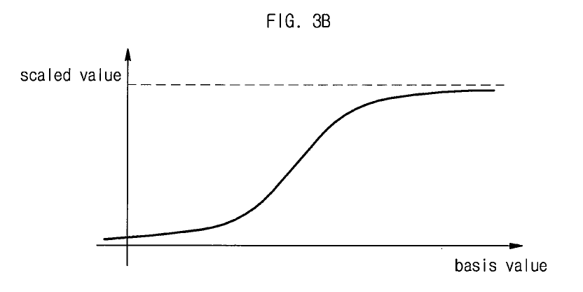

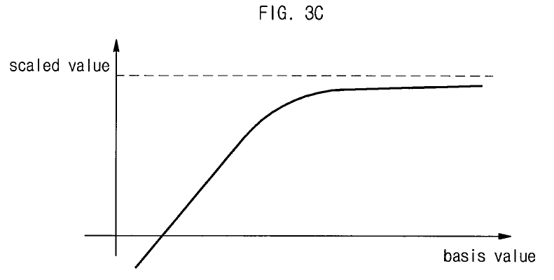

The content credibility calculating part 134 calculates the content credibility based on the content information, the user information and the evaluation information obtained by the user information obtaining part 131 and the content information obtaining part 132. The calculated content credibility may be transmitted to the content credibility significance determining part 135, the user credibility updating part 136 and content server 120. A content credibility evaluation method will be described in detail, referring to FIG. 2. Scaling functions used in a credibility evaluation process will be described in detail, referring to FIG. 3A to 3C.

The content credibility significance determining part 135 determines whether the content credibility from the content credibility calculating part 134 is statistically significant or not.

For an example, about a normal distribution of the content credibility, a content credibility value far from the center value by a certain level of significance may be determined not to be significant. The credibility evaluation result that is not statistically significant may be excluded in updating user credibility.

The level of significance may be varied by an operator of a credibility evaluation server. For an example, the level of significance may be 1% or 5%, but not limited to them. Also, the level of significance is controlled to keep a certain portion of content credibility evaluation results significant.

The content credibility evaluation result that is not significant may be excluded in updating credibility of a content poster and/or a content evaluator. Thus, a bias in the content credibility evaluation may be diminished.

The user credibility updating part 136 may update a user credibility based on the content credibility obtained from the content credibility calculating part 134. The updating of a user credibility may be fulfilled by transmitting an updated user credibility information from the credibility evaluation server 130 and the user information server 140.

In an embodiment of the invention, content having a high credibility may be reflected affirmatively to the credibility of a content poster. Accurate evaluation grade, from a content evaluator, close to a calculated content credibility may be reflected affirmatively to the credibility of a content evaluator. The content credibility may affect updating of the credibility of a content poster and a content evaluator. As a user may be a content poster and a content evaluator for another's content, realization of a recurrent user credibility updating method may contribute to diminishing of biases in the content evaluation. Also, user credibility updating will be described in detail referring to other figures.

The user information server 140 may include a user information database 141 and an evaluation information database 142. The user information database 141 may store a user credibility and user identification information etc. The evaluation information database 142 may store information about content evaluator's response inputted to the user terminal 110. The user information server 140 may transmit user information and evaluation information of a content evaluator to the user information obtaining part 131. Also, the user information server 140 may update user credibility by a request of the user credibility updating part 136. The user information server 140 may communicate with other servers and the user terminal 110 like this.

The user information stored in the user information database 141 may include user credibility. The user information may be stored for each user. User identification information may be required to maintain user information for each user. The user identification information may be user login information, identification information of the user terminal 110 and IP address information of the terminal. Also, a user can be identified by authentication with a personal device like a mobile phone.

The user credibility may be understood as a measure for influencing power of a user. As users have different attainments, it is not efficient that all users' influencing power are considered equally in the content credibility evaluation. The concept of user credibility may provide a guide for importance allotment.

User credibility may have distinct values for content themes. A same user may have a different credibility value for the economy field from that for the sports field. Also, credibility for a super-ordinate theme (field) may be calculated based on credibility for subordinate themes (fields) that belong to the super-ordinate theme. For example, user credibility for the sports field may be calculated, as a sum or an average, based on user credibility of baseball, soccer and basket ball fields etc.

A user credibility may be a numerical value, that can be varied continuously, and be a ranked value. For the ranked value credibility, the user credibility may have the same value for users who have satisfied a predetermined criterion. For the numerical value credibility, that can be varied continuously, a scaling function may be applied for scaling of credibility. The credibility of users may have same initial value when a user account is generated.

The evaluation information database 142 may store information about evaluation by a content evaluator. As mentioned above, the evaluation information may include an evaluation grade inputted to the user terminal 110 by a content evaluator, and time information when the evaluation grade is given. In an embodiment of the invention, an evaluation grade may be a mark for content, a for/against opinion and a selective opinion.

The network 150 is a wired/wireless communication network which interconnects the user terminal 110, the content server 120, the credibility evaluation server 130 and the user information server 140. Information exchanges among the terminals and servers may be performed in accordance with a predetermined communication protocol. An access to the databases 121,122,141,142 may be performed by requesting information to the servers 120,140 that maintain the databases or by requesting directly to the databases. The network may not be a single unified network. Also, the network may be realized by ADSL, VDSL, Wi-Fi, WIBRO and HSDPA technologies. A VPN technology may be utilized for security,

FIG. 2 is a flow chart of a content credibility evaluation method according to an embodiment of the invention.

Referring to FIG. 2, a method of evaluating the content credibility including obtaining user information S210, obtaining content information S220 and calculating content credibility S230 is disclosed. The content credibility evaluation method may further include providing content credibility S240, determining evaluation ending time S250, determining content credibility significance S260, updating poster credibility S270 and updating evaluator credibility S280.

In the step of obtaining user information S210, the user information obtaining part 131 may obtain user information from the user information server 140. When a content evaluator's response is received from the user terminal 110, the user information obtaining part 131 may request to the user information server 140 to send user information of the content evaluator. The obtained user information may be used as a basis for calculating content credibility in the step of calculating content credibility S230. As mentioned above, the user information may include user identification information—a user login ID or an IP address of a user terminal, an additional information of a user condition, a user credibility and a user credibility modification history information. When the user identification information is not available or insufficient, an exceptional handling will be performed and the exceptional handling will be described in description of the calculating content credibility S230.

In the step of obtaining content information S220, the content information obtaining part 132 obtains content information from the content server 120. As mentioned above, the content information may include content evaluation ending condition and content evaluation type information. The obtained user information may be a content credibility calculation factor in calculating content credibility S230.

In the step of calculating content credibility S230, the credibility evaluation server 130 may calculate the content credibility based on user credibility and evaluation information etc. The calculated content credibility may be transmitted to the content server 120.

In the calculating content credibility S230, a credibility of a content evaluator may be considered. According to the credibility of a content evaluator, same evaluation grades may have different reflection to the content credibility evaluation. The credibility of a content evaluator may be considered as a weight factor in calculating content credibility.

In an embodiment of the invention, for a mark giving type content evaluation, the content credibility may be calculated based on an evaluation grade weighted by the content evaluator credibility. Sum or average of evaluation grades may be a basis value in the content credibility calculation. A ranked content credibility may be given considering the basis value credibility. Also, the basis values may be converted to the content credibility by a scaling function. The scaling function may be a linear and a non-linear function. The scaling function used in a credibility evaluation process will be described in detail, referring to FIGS. 3A to 3C.

Additional information such as content evaluator's occupation, residence region, and age etc. may be reflected to the content evaluator credibility. In case that the additional information is reflected directly to the content evaluator credibility, the additional information may affect all content evaluation of the content evaluator. Meanwhile, the additional information may be reflected optionally, according to theme of content, to the content evaluation.

In step of the calculating content credibility S230, credibility of a content poster may be used. An initial credibility of content may be given according to credibility of a content poster. The content poster's occupation, residence region, and age etc. are also considered. Also, the content poster may be a content evaluator for his own content. In this case, the content poster is considered as a most friendly content evaluator in giving evaluation grade.

The calculating content credibility S230 may include an exceptional handling process. In case the user identification information is not available or insufficient or exact IP information of the user terminal 110 is not available by a proxy, a unidentified content evaluator may be classified as an anonymous content evaluator. The evaluation information of anonymous content evaluators may be excluded from calculation of the content credibility.

In case evaluation information of anonymous content evaluator is included in calculating the content credibility, the credibility of anonymous content evaluator may have same value as a initial value of the user credibility. The credibility of anonymous content evaluator may be set corresponding to an average of the evaluator credibility who participated in the content evaluation. To be set correspondingly may include to be set in proportion, in inverse proportion, and in same.

For another example to deal with exceptional cases, evaluations by extraordinary evaluators, who give max/min evaluation grades for all contents or give same evaluation grades for all contents, may be excluded from the calculation of the content credibility.

In updating the evaluator credibility S280, the credibility of these extraordinary evaluators may be diminished gradually. Thus, influence of these extraordinary evaluators in the content credibility evaluation may be also be diminished gradually. Nevertheless, direct exclusion of these trivial cases may be considered.

As described above, the content credibility may be considered as a measure to evaluate content, not a measure about veracity of subject matters of content.

In the step of providing content credibility S240, the content server 120 may provide the content credibility to a user. The content server 120 may store the content credibility, transmitted from the credibility evaluation server 130, to the credibility database 122 and transfer to the user terminal 110. The content credibility may be provided with and without a user request. The content credibility may be provided together with the content.

In an embodiment of the invention, the content credibility may be provided to a user in substantially real-time, during the credibility evaluation process. When the content credibility is provided from the initial stage of the content credibility evaluation, it may induce a bias in the content evaluation. The content credibility may be provided to a user if only a minimum number of content evaluators to make content evaluation result statistically significant is reached, a predetermined number of content evaluators is reached, or influence of additional content evaluators is smaller than a predetermined level. In an embodiment of the invention, the number of content evaluators to make the content credibility significant may be calculated by formula 1,

$$N = {( \frac{z ( a / 2 ) \cdot s}{d} )}^{2} \qquad [ formula 1 ]$$

Wherein N is a number of content evaluators, (1−a) is a level of confidence, s is a standard deviation, d is bound on the error of estimation, z is a standard normal distribution function.

In determining evaluation ending time S250, the evaluation ending condition determining part 133 may determine whether additional responses (evaluation) by a user may be accepted or not. In case the evaluation ending time is reached, the content credibility may be calculated based on the responses (evaluations) that made before the evaluation ending time.

An evaluation ending condition may be obtained by the content information obtaining part 132 from the content server 120. The evaluation ending condition may be set by a content poster. The evaluation ending condition may include an evaluation ending time and/or a requirement for the number of evaluators. In an embodiment of the invention, the evaluation ending time may be reached by satisfying a minimum number of evaluators to make the evaluation statistically significant.

In case the evaluation ending time is not reached, the credibility evaluation server 130 may back to the obtaining user information S210 and wait for content evaluator's responses. In case the evaluation ending time is reached, the determining content credibility significance S260 may be performed by the credibility evaluation server 130.

In determining content credibility significance S260, the content credibility significance determining part 135 may determine statistical significance of the content credibility calculated by the content credibility calculating part 134. In case the content credibility is statistically significant, the user credibility updating part 136 may reflect the content credibility to credibility of a content poster and/or a content evaluator.

The determining content credibility significance S260 is performed by a statistical method. In an embodiment of the invention, the content credibility significance may be determined by considering a credibility distribution of another content group. The other content group, which is considered in determining the content credibility significance, may be the overall contents that have the significant credibility. Significance of the content credibility may be determined within the content groups having the same content posters or the content groups having the same themes (subject matters).

In an embodiment of the invention, the content credibility distribution may be a normal distribution. In this case, because the content credibility, that locates excessively deviated from the mean value, may be a fabricated by groups providing a biased evaluation and meaningless result due to being too obvious, it may be improper to be used as a basis in updating the user credibility.

In the step of updating poster credibility S270, the user credibility updating part 136 may update credibility of a content poster based on the content credibility.

In an embodiment of the invention, credibility of a content poster may be updated based on statistically significant content credibility, the number of content evaluators and content evaluation ending time etc. The number of content evaluators and the content evaluation ending time may be considered as a weight in calculation of the content credibility. The calculated content credibility may be a basis value of the content poster credibility updating. An evaluation result by relatively large number of evaluators may have larger influence that that by relatively small number of evaluators. In case that the content evaluation ending time is considered as a weight in calculation of the content credibility, the credibility of content posters can be determined to have less influence for relatively aged evaluation result such as applying a half-life or to consider evaluation grades for a certain period of time. In case that the number of content evaluators and the content evaluation ending time are not considered, an average of the content credibility may be a basis value of the content poster credibility updating. A scaling function may be used in updating the credibility of content posters considering the basis value. The scaling function may normalize the basis value or convert to a log-scale.

In the step of updating evaluator credibility S280, the user credibility updating part 136 may update the credibility of content evaluators considering the content credibility.

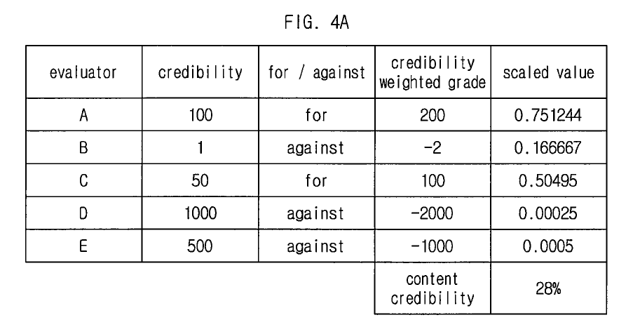

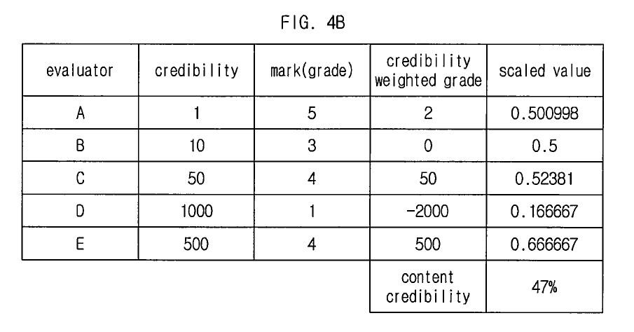

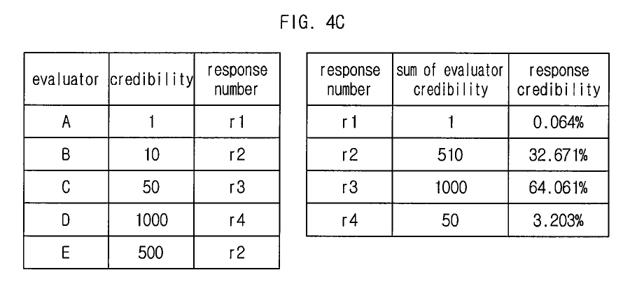

In an embodiment of the invention, the credibility of a content evaluator may be updated based on accuracy of evaluation that he has been participated. The accuracy of evaluation may be proximity of an evaluation grade given by an evaluator to the credibility evaluation result. The proximity may be calculated by statistical analysis. An evaluation grade close to the content credibility evaluation result may have a positive influence to the evaluator credibility. Credibility of extraordinary evaluators, who give the maximum/minimum evaluation grades for all contents or give same evaluation grades for all contents, may be diminished, with repeating evaluation. Updating the credibility of a content evaluator according to a type of content evaluation is described in detail with referring to FIG. 4.

An evaluator credibility may be stored as a numerical value, that can be varied continuously and a linear of non-linear scaling function may be applied during scaling the evaluator credibility. The same credibility grade may be applied for evaluators who have satisfied a predetermined criterion.

In an embodiment of the invention, a user may be a content poster and a content evaluator. Though updating method for a content poster may differs from updating method for a content evaluator, updating target may be a user credibility stored in the user information database 141. In case the user credibility is updated by the two steps S270 and S280, a recurrent evaluation among users is available by repeated evaluations.

In an embodiment of the invention, satisfaction of the content evaluation ending condition and statistical significance of the content credibility may be a premise condition of updating the user credibility S270, S280. Meanwhile, in other embodiments of the invention, this premise condition may be omitted.

FIGS. 3A to 3C illustrate scaling functions according to an embodiment of the invention. In step of calculating the content credibility S230 and updating the user credibility S270, S280, a basis value may be calculated. The basis value scaled with a scaling function may be used in calculating the content credibility and updating the user credibility. Also, a scaling function may be used in evaluation of evaluator credibility and content poster credibility.

Referring to FIG. 3A, a ‘step’ scaling function is illustrated. In this scaling function, basis values in a certain range are converted to the same scaled value. Referring to FIG. 3B and FIG. 3C, nonlinear scaling functions having a minimum and a maximum are illustrated. By utilizing a minimum and a maximum given by the scaling function, a distortion in the content credibility evaluation results, by users who have excessively large or small credibility, may be prevented. The scaling function may be varied in content credibility evaluation processes.

FIGS. 4A to 4C illustrate calculation results according to an embodiment of the invention.

Referring to FIG. 4A, a content credibility calculation process for a for/against opinion type content evaluation is illustrated. A ‘for’ opinion of a content evaluator is considered as a evaluation grade ‘2’ and an ‘against’ opinion is considered as a evaluation grade ‘−2’. A credibility reflected grade, weighted by the credibility of the content evaluators, may be an evaluation grade multiplied by the credibility. For evaluator A, having the credibility of 100 and giving a for opinion that has a ‘2’ evaluation grade, the credibility reflected (weighted) evaluation grade is 200. This credibility reflected evaluation grade is scaled to 0.751244. By averaging five users' credibility reflected (weighted) evaluation grades, a content credibility of 28% is calculated. The content credibility of 28% is closer to ‘against’ opinion than ‘for’ opinion. In this case, by updating the evaluator credibility S280, the credibility of a content evaluator who gives a ‘against’ opinion may be updated affirmatively (positively) and the credibility of a content evaluator who give a ‘for’ opinion may be updated negatively.

Referring to FIG. 4B, a content credibility calculation process for an mark giving (grade giving) type content evaluation is illustrated.

A content evaluator may select a mark between 1 and 5. In calculation process, the mark may be converted to an evaluation grade which can vary from −2 to 2. A neutral mark of 3 is converted to an evaluation grade of 0 and a max mark of 5 is converted to an evaluation grade of 2. About the content evaluator C, a credibility reflected grade of 50 is obtained, by multiply a converted evaluation grade of 1 (value subtracted 3 from the mark grade of C) by the credibility of C of 50. The credibility reflected (weighted) grade is scaled to a value of 0.52381. A content credibility of 47% is obtained by summing scaled values.

Referring to FIG. 4C, a content credibility calculation process for a survey type content evaluation type is illustrated.

In an embodiment of the invention, a content evaluator may give a selective opinion by choosing a response among four responses from ‘r1’ to ‘r4’. Credibility of the content evaluator may be summed for each response and be a basis of the response credibility. For a response of ‘r2’, sum of credibility of evaluators who choose ‘r2’ is 510—summing credibility of the evaluator B and E. The response credibility may be proportion of the response in total sum of the evaluator credibility. The response credibility of ‘r2’ is obtained by dividing 510 (sum of credibility of evaluators who choose ‘r2’) by the total sum of credibility of 1561.

FIGS. 4A to 4C illustrate content credibility evaluation processes based on evaluation grade given by a content evaluator. Credibility of a content poster and additional information about the content poster may be considered in content credibility evaluation.

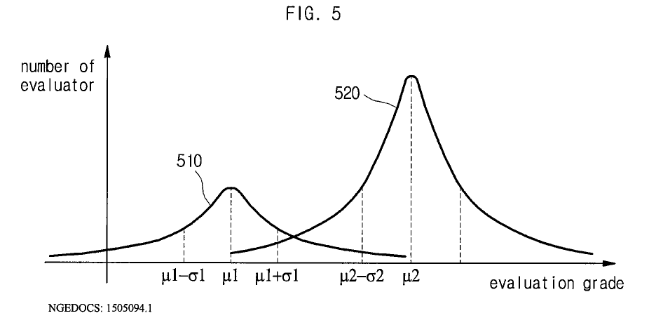

FIG. 5 is a distribution of the evaluation grade given by content evaluators according to an embodiment of the invention.

Referring to FIG. 5, there are shown evaluation grade distributions 510 and 520. The distribution 510 is formed by evaluators who give relatively low grade. The distribution 520 is formed by evaluators who give relatively high grade.

The evaluation grade distribution 520 has a center value of μ2 and a standard deviation of σ2. For a content evaluator who gave a evaluation grade close to μ2, there may be a positive updating of the user credibility as a reward for an accurate evaluation. But for a content evaluator who gave a evaluation grade far from μ2, there may be a negative updating of user (evaluator) credibility. The standard deviation of σ2 may be a criterion determining the accuracy of evaluation.

Two distributions 510, 520 may composed to be a mixed evaluation grade distribution. In this case, the credibility evaluation result of content may locate between μ1 and μ2. The content credibility evaluation grade—between μ1 and μ2 may be a basis for calculating evaluator's evaluation accuracy. According to shape of evaluation grade distribution μ1 or μ2 may be a basis for calculating evaluator's evaluation accuracy. There may be a penalty in credibility for a user who gave excessively lower evaluation grade than μ1 or gave excessively higher evaluation grade than μ2.

Meanwhile, the content credibility evaluation method may be written as a computer program. Codes and code segments that compose the program may be deduced easily by a comport programmer in the field of art to which the present invention belongs. Also, the program may be stored a computer readable information storing medium. The content credibility evaluation method may be realized by the program read and executed by a computer. The information storing medium may include a magnetic medium, optical medium and a carrier wave medium.

According to certain embodiments of the invention as set forth above, as mentioned above, an improved content credibility evaluation method considering evaluator credibility in content credibility evaluation. The improved content credibility evaluation method may be applied to improve performance of a search engine.

Also, a recurrent user credibility evaluation apparatus may be realized by reflecting a content credibility evaluation result to credibility of a content evaluator and a content poster. Thus, distortion in content credibility by an extraordinary user group may be diminished. Also influence of a spam content may be diminished for a search engine.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A method of evaluating content credibility by a credibility evaluation server, the method comprising:
obtaining evaluation information of a content evaluator about content;
obtaining credibility of the content evaluator from a user information database; and
calculating content credibility based on the credibility of the content evaluator and the evaluation information.

2. The method of claim 1, wherein the evaluation information includes an evaluation grade about the content.

3. The method of claim 1, wherein in the step of calculating content credibility, the credibility of the content evaluator is reflected as a weight for the evaluation grade.

4. The method of claim 1, further comprising updating credibility of a content poster of the content, based on the content credibility.

5. The method of claim 4, wherein the updating credibility of a content poster is performed in case the content credibility is statistically significant based on a predetermined criterion.

6. The method of claim 4, wherein the updating credibility of a content poster is performed after an evaluation ending time assigned by the content poster or calculated in accordance with a predetermined criterion.

7. The method of claim 4, further comprising updating credibility of the content evaluator based on the content credibility and the evaluation information.

8. The method of claim 1, further comprising updating credibility of the content evaluator based on the content credibility and the evaluation information.

9. The method of claim 1, further comprising providing the evaluated content credibility to an online user.

10. The method of claim 9, wherein the providing the content credibility is performed in case a minimum number of content evaluators, calculated by a predetermined criterion, is reached.

11. Content credibility evaluation apparatus comprising:
content information obtaining part, configured to obtain evaluation information of a content evaluator about content from a user terminal;
a user information obtaining part, configured to obtain credibility of the content evaluator from a user information database; and
a content credibility calculating part, configured to calculate the content credibility based on the credibility of the content evaluator and the evaluation information.

12. The apparatus of claim 11, wherein the evaluation information includes an evaluation grade about the content.

13. The apparatus of claim 11, wherein the content credibility calculating part calculates the content credibility based on a sum of the evaluation grade weighted by the credibility of the content evaluator.

14. The apparatus of claim 11, further comprising a user credibility updating part, configured to update credibility of the content evaluator and/or a content poster of the content based on the content credibility.

15. The apparatus of claim 14, further comprising a content credibility significance determining part configured to determine significance of the content credibility.

16. The apparatus of claim 15, wherein the content credibility significance determining part activates the user credibility updating part, only if the content credibility is determined to be statistically significant.

17. The apparatus of claim 14, further comprising an evaluation ending condition determining part configured to determine whether an evaluation ending time is reached.

18. The apparatus of claim 17, wherein the evaluation ending condition determining part activates the user credibility updating part, only if the evaluation ending time is reached.

19. A recorded medium readable by a computer having a program recorded thereon for performing a method of evaluating content credibility comprising:
obtaining evaluation information of a content evaluator about content;
obtaining credibility of the content evaluator from a user information database; and
calculating content credibility based on the credibility of the content evaluator and the evaluation information.
